(19) United States
(12) Patent Application Publication
(10) Pub. No.: US 2013/0154158 A1
(43) Pub. Date: Jun. 20, 2013

(54) METHOD AND MOLD FOR MANUFACTURING A TANK HAVING A SLIDE DRUM AND FOLLOWER PISTON

(71) Applicants: Laurent Decottignies, Cergy (FR); Ludovic Goudigan, Epinay (FR)

(72) Inventors: Laurent Decottignies, Cergy (FR); Ludovic Goudigan, Epinay (FR)

(73) Assignee: APTAR FRANCE S.A.S., Le Neubourg (FR)

(21) Appl. No.: 13/805,882

(22) PCT Filed: Jun. 20, 2011
(86) PCT No.: PCT/FR2011/051404

§ 371 Date: Mar. 8, 2013

(30) Foreign Application Priority Data
Jun. 23, 2010 (FR) 1054978

(51) Int. Cl. B29C 45/00

(52) U.S. Cl. CPC B29C 45/00
USPC 264/328.14; 425/577

(57) ABSTRACT

A method of manufacturing a fluid reservoir (1) for associating with a dispenser member (4), such as a pump, so as to constitute a fluid dispenser, the reservoir (1) including an inside surface (12) that is circularly cylindrical and that defines a slide cylinder in which a follower piston (2) slides in leaktight manner, the reservoir (1) including an outside surface (13) of any shape that is spaced apart from the inside surface by a wall thickness (Emin) that varies, the method comprising molding the reservoir (1) in a mold with a melt of plastics material, the method being characterized in that the inside surface (12) is formed by a non-circularly-cylindrical molding pin, so as to take account of phenomena of material shrinkage after cooling, so as to obtain an inside surface (12) that is circularly cylindrical.

The present invention relates to a method and to a mold for manufacturing a fluid reservoir for associating with a dispenser member, such as a pump, so as to constitute a fluid dispenser. In general, the pump is a manual pump on which the user can press so as to dispense a dose of fluid from the reservoir. This type of dispenser is frequently used in the fields of cosmetics, perfumery, and even pharmacy.

The present invention relates to a particular type of reservoir, namely a reservoir including an inside surface that is circularly cylindrical and that defines a slide cylinder for a follower piston that slides in leaktight manner inside the cylinder. The reservoir also includes an outside surface of any shape that is spaced apart from the circularly-cylindrical inside surface by a wall thickness that varies. In other words, the outside surface does not have the same shape as the circularly-cylindrical inside surface. As a result, the wall thickness of the reservoir varies from one location to another, and more particularly it is the thickness in the radial direction going away from the axis of symmetry of the reservoir that varies, if there is such an axis of symmetry.

In order to manufacture this type of fluid reservoir having a slide cylinder that is circularly cylindrical, a specific mold is used for injecting a melt of plastics material. In order to make the slide cylinder, the bottom of the reservoir is open in such a manner as to be suitable for engaging a molding pin that is to define the circularly-cylindrical inside surface of the slide cylinder. After molding, and generally before the plastics material has cooled, the molding pin is removed, leaving the inside surface exposed to the surrounding air. In this way, the reservoir cools, thus inevitably being subjected to material-shrinkage phenomena, well known in the field of molding plastics material. Finally, after complete cooling, the inside surface of the reservoir is no longer perfectly circular, thereby allowing fluid to leak during sliding of the follower piston that is itself perfectly circular. Thus, the use of a conventional molding pin does not make it possible to obtain an inside surface that is suitable for use as a slide cylinder for a follower piston.

In the prior art, document FR 2 718 417 is known that describes a follower piston presenting an outer contact periphery that is of shape that is oblong, having two portions of greater curvature that are defined by a pair of circular arcs of the same radius of curvature, said circular arcs being arranged relative to each other in a first specular symmetry and being connected to each other by connection segments that are defined by a pair of circular arcs of the same radius of curvature as each other and that are arranged relative to each other in a second specular symmetry that is perpendicular to the first specular symmetry. The piston of shape that is generally oval is supposed to solve the phenomenon of material shrinkage after cooling. In some circumstances, the oval piston offers an acceptable solution, but it requires very great accuracy, and as a result leads to very high manufacturing cost. Furthermore, it is limited to a piston of shape that is oval.

An object of the present invention is to remedy the above-mentioned drawbacks of the prior art by defining a manufacturing method that makes it possible to make a circularly-cylindrical inside surface that is suitable for being used as a slide cylinder for a conventional circularly-cylindrical follower piston, while the visible outside surface of the reservoir presents any shape, preferably a cylindrical shape that is not necessarily a circular cylindrical shape.

To do this, the method of the present invention provides for forming the circularly-cylindrical inside surface of the reservoir with a molding pin that is cylindrical but not circular, having a shape that is suitable for taking account of material-shrinkage phenomena, so as to obtain an inside surface that is circularly cylindrical after the plastics material has cooled. Advantageously, in cross-section, the molding pin defines transverse dimensions that decrease with increasing wall thickness of the reservoir. In other words, the transverse dimensions of the molding pin are inversely proportional to the wall thicknesses of the reservoir. This is explained by the fact that the material-shrinkage phenomenon increases with increasing material thickness. By modeling or by empirical testing, it is possible to define, with accuracy, the non-circular shape required for the molding pin in order to form an inside surface that is accurately cylindrical and circular for an outside surface of given shape. In order to make it possible for the plastics material to be subjected to the material-shrinkage phenomena without being stressed, the molding pin is removed before the plastics material has cooled.

The invention also defines a mold for manufacturing a fluid reservoir for associating with a dispenser member, such as a pump, so as to constitute a fluid dispenser, the reservoir including an inside surface that defines a circularly-cylindrical slide cylinder in which a follower piston slides in leaktight manner, the reservoir including an outside surface that is spaced apart from the inside surface by a wall thickness that varies, the mold being characterized in that it includes a non-circularly-cylindrical molding pin for forming the inside surface so as to take account of phenomena of material shrinkage after cooling, so as to obtain an inside surface that is circularly cylindrical. Advantageously, in cross-section, the molding pin defines transverse dimensions that decrease with increasing wall thickness of the reservoir.

The spirit of the invention relies on the principle according to which, in cross-section, the shape of the cylindrical molding pin is adapted as a function of the local wall thickness of the reservoir, so as to form a non-circularly-cylindrical inside surface that, after material shrinkage, transforms into an inside surface that is circularly cylindrical.

The invention is described more fully below with reference to the accompanying drawing that shows two embodiments of the invention by way of non-limiting example.

### In the figures:

FIG. 1 is a vertical section view through a fluid dispenser including a fluid reservoir of the invention;

FIG. 2a is a horizontal cross-section view through the FIG. 1 fluid reservoir after the reservoir has been cooled.

FIG. 2b is a view similar to the view in FIG. 2a during the molding operation; and

FIGS. 3a and 3b are views corresponding to FIGS. 2a and 2b respectively for a second embodiment of a reservoir of the invention.

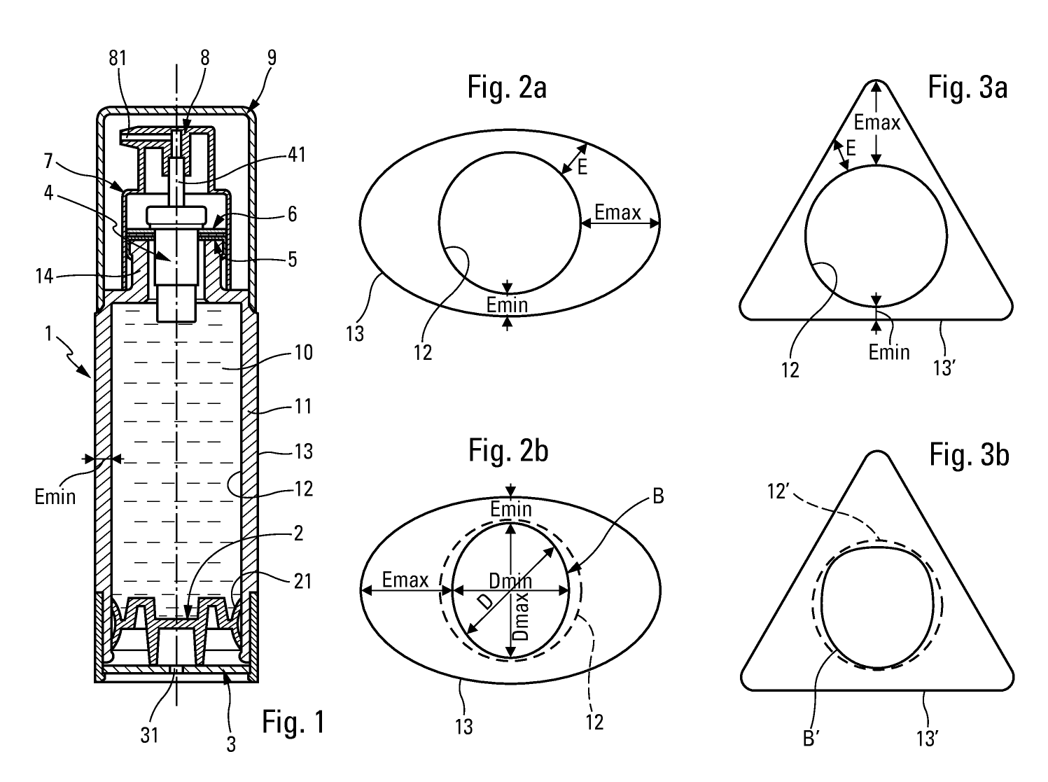

The fluid dispenser shown in FIG. 1 is a dispenser of conventional design, except that its fluid reservoir 1 is made in accordance with the invention. The fluid reservoir 1 comprises a reservoir body 11 having a bottom end that is open and a top end that forms a neck 14 of constricted section. The body 11 defines an inside surface 12 and an outside surface 13. Between the two surfaces 12, 13, the body 11 of the reservoir presents a wall thickness that is constituted by plastics material. In FIG. 1, the wall thickness is the minimum wall thickness, as described below. The inside surface 12 is cylindrical and circular so as to define a leaktight slide cylinder for a follower piston 2 that, during operation of the dispenser, moves in leaktight manner inside the slide cylinder. The follower piston 2 includes a sealing lip 21 for sliding in leaktight manner inside the slide cylinder. In other words, the follower piston 2 defines a movable bottom wall for the reservoir 1. Its movement inside the slide cylinder is generated by suction applied on successive occasions to the inside of the reservoir, as described below. For reasons of appearance and of safety, the reservoir 1 may have a stationary bottom wall 3 that is fitted thereto and that presents a vent hole 31 as is needed for the follower piston 2 to slide properly. For reasons of simplicity in manufacture, of effectiveness, and of cost, the sealing lip 21 of the follower piston 2 presents a shape that is circularly cylindrical. The same applies for the inside surface 12, thereby making it possible for the follower piston 2 to slide in completely leaktight manner inside the slide cylinder. Until the present, despite numerous unsuccessful attempts, it has not been possible to make the follower piston and the slide cylinder with a shape that is other than circular.

The prior art has always sought to make fluid reservoirs with a wall thickness that is constant so as to avoid material-shrinkage phenomena. This is why most fluid reservoirs on the market present an outside surface having a cross-section that is circular. The present invention departs from those conventional prior-art reservoirs in that the wall thickness of the reservoir is not constant between the inside surface that is circularly cylindrical and the outside surface 13 that is cylindrical but with a cross section of any shape. How the invention solves the material-shrinkage phenomenon is described below.

The FIG. 1 fluid dispenser also includes: a dispenser member 4 that, in this embodiment, is a pump that defines a fluid inlet that communicates with the reservoir; and an actuator rod 41 that is axially movable down and up so as to dispense doses of fluid. The dispenser member 4 is mounted in permanent and leaktight manner on the neck 14 of the reservoir by a fastener ring 6 and a neck gasket 5. For reasons purely of appearance, the fastener ring 6 is surrounded by a covering hoop 7 that is preferably made of metal. The actuator rod 41 is covered by a pusher 8 that defines a dispenser orifice 81. By pressing on the pusher 8, the actuator rod 41 is driven downwards, thereby causing fluid to be dispensed. Optionally, the top portion of the dispenser may be protected by a cap 9 that the user must remove beforehand so as to actuate the pusher 8. This configuration is entirely conventional for a fluid dispenser in the fields of cosmetics, perfumery, and even pharmacy. Follower-piston reservoirs are nevertheless more suitable for dispensing pasty fluids, such as creams, pomades, etc.

FIG. 2a shows the cross-section of the reservoir 1 at its body 11. It should be observed that the inside surface 12 is accurately cylindrical and circular, whereas the outside surface 13 presents a shape that is oblong or oval. Thus, the wall thickness E of the reservoir varies between a minimum thickness Emin and a maximum thickness Emax. In order to obtain such a configuration with an inside surface 12 that is accurately cylindrical and circular, the present invention makes provision to form the inside surface 12 with a molding pin B that is cylindrical but not circular, and that has dimensions, in cross-section, that are adapted to take account of phenomena of material shrinkage after cooling, so as to obtain an inside surface 12 that is accurately cylindrical and circular after cooling. It can be seen in particular in FIG. 2b that the molding pin B presents a maximum dimension Dmax and a minimum dimension Dmin at the locations in which the wall thickness E of the reservoir presents the wall thicknesses Emin and Emax respectively. In other words, the transverse dimensions of the molding pin B decrease with increasing wall thickness of the reservoir. It can also be said that the transverse dimensions of the molding pin B are inversely proportional to the wall thicknesses of the reservoir. In FIG. 2b, the circularly-cylindrical inside surface 12 after cooling is shown by dashed lines.

FIGS. 3a and 3b show another embodiment for a fluid reservoir of the invention, with an outside surface 13′ of shape that is substantially triangular in cross-section. Once again, in order to obtain a circularly-cylindrical inside surface 12, a molding pin B′ is used that is of a shape that is cylindrical but not circular, as can be seen in FIG. 3b. In cross-section, the dimension of the pin B′ is at its minimum at the vertices of the triangle, given that the wall thickness of the reservoir is at its maximum at said vertices.

The present invention applies to any shape of cylindrical outside surface other than circular, by designing a specific molding pin having a section that is adapted to the material-shrinkage phenomenon and to the shape of the section of the outside surface.

The molding pin forms part of a complete mold that also makes it possible to form the outside surface 13 of the reservoir, and the neck 14.

1. A method of manufacturing a fluid reservoir (1) for associating with a dispenser member (4), such as a pump, so as to constitute a fluid dispenser, the reservoir (1) including an inside surface (12) that is circularly cylindrical and that defines a slide cylinder in which a follower piston (2) slides in leaktight manner, the reservoir (1) including an outside surface (13, 13′) of any shape that is spaced apart from the inside surface by a wall thickness (E, Emax, Emin) that varies, the method comprising molding the reservoir (1) in a mold with a melt of plastics material, the method being characterized in that the inside surface (12) is formed by a non-circularly-cylindrical molding pin (B; B′) having a shape that is suitable for taking account of phenomena of material shrinkage after cooling, so as to obtain an inside surface (12) that is circularly cylindrical.

2. A manufacturing method according to claim 1, wherein in cross-section, the molding pin (B; B′) defines transverse dimensions (D, Dmax, Dmin) that decrease with increasing wall thickness (E) of the reservoir.

3. A manufacturing method according to claim 2, wherein the molding pin (B; B′) is removed before cooling.

4. A mold for manufacturing a fluid reservoir (1) for associating with a dispenser member (4), such as a pump, so as to constitute a fluid dispenser, the reservoir (1) including an inside surface (12) that defines a circularly-cylindrical slide cylinder in which a follower piston (2) slides in leaktight manner, the reservoir (1) including an outside surface (13, 13′) that is spaced apart from the inside surface by a wall thickness (E, Emax, Emin) that varies, the mold being characterized in that it includes a non-circularly-cylindrical molding pin (B; B′) for forming the inside surface (12), so as to take account of phenomena of material shrinkage after cooling, so as to obtain an inside surface (12) that is circularly cylindrical.

5. A mold according to claim 4, wherein in cross-section, the molding pin (B; B′) defines transverse dimensions (D, Dmax, Dmin) that decrease with increasing wall thickness (E, Emax, Emin) of the reservoir.
